(19) United States
(12) Patent Application Publication
(10) Pub. No.: US 2011/0042935 A1
(43) Pub. Date: Feb. 24, 2011

(54) Conduit/Piping Sump Penetration Fitting

(76) Inventors: Belinda Bain, Laguna Niguel, CA (US); Jamil Hershewe, Long Beach, CA (US)

Correspondence Address: STETINA BRUNDA GARRED & BRUCKER, 75 ENTERPRISE, SUITE 250, ALISO VIEJO, CA, 92656, US

(21) Appl. No.: 12/546,010

(22) Filed: Aug. 24, 2009

(51) Int. Cl. F16L 21/00; F16L 55/00

(52) U.S. Cl. 285/31; 285/24

(57) ABSTRACT

A conduit/piping sump penetration fitting is disclosed. The conduit/piping sump penetration fitting may comprise a bulk head fitting which does not require a plurality of mounting holes to mount the bulk head fitting to a sump wall. Rather, the bulk head fitting has a flange and a threaded portion. Opposed sides of the sump wall may have a rubber gasket through which the threaded portion is fed. A compression flange and compression nut compress the rubber gaskets onto the sump wall so as to form a fluid tight seal between the bulk head fitting and the sump wall. The threaded portion may have an internal beveled surface at its distal end portion which receives an o-ring. A conduit/piping is disposed in the bulk head fitting with the o-ring disposed about the conduit/piping. A second compression nut is threaded onto the threaded portion of the bulk head fitting which pushes the o-ring further down the internal beveled surface. This action causes the o-ring to compress upon the conduit/piping and form a fluid tight seal between the o-ring with the internal beveled surface and the conduit/piping exterior surface.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a conduit/piping sump penetration fitting for providing a fluid tight seal between a sump wall and a conduit/piping.

Referring now to FIG. 1, a prior art fitting is shown. The fitting may comprise a rubber cylindrical portion combined with a unitary rubber flange. The rubber flange may have a plurality of threaded studs. The sump wall may be formed with a main hole and a plurality of mounting holes which receive the threaded studs. A compression flange is disposed over the threaded studs and a plurality of nuts are threaded onto the threaded studs to provide a fluid tight seal between the sump wall and the fitting. A conduit/piping is disposed through the cylindrical portion and a clamp compresses the rubber cylindrical portion onto the conduit/piping to form a fluid tight seal between the conduit/piping and the fitting.

Unfortunately, the prior art fitting requires a plurality of mounting holes which each provide an opportunity or the possibility of leakage. Additionally, the nuts threaded onto the threaded portion must be tightened down to a specific torquing requirement thereby adding additional time and cost to install the prior art fitting to the sump wall.

### BRIEF SUMMARY

The present invention addresses the needs discussed above, discussed below and those that are known in the art.

A conduit/piping sump penetration fitting that requires only a main hole formed in the sump wall without any additional mounting holes is disclosed herein. In particular, one main hole is formed in the sump wall. A bulk head fitting with a rubber gasket is mounted to the main hole. On an opposed side of the sump wall, a second rubber gasket is disposed on the bulk head fitting along with a compression flange. When the rubber gaskets are compressed onto the sump wall, a fluid tight seal is provided between the bulk head fitting and the sump wall. A compression nut is threaded onto the bulk head fitting. Preferably, the compression nut is hand tightened and may optionally be turned an additional one quarter to one half turn with a wrench after hand tightening. This provides a fluid tight seal between the bulk head fitting and the sump wall. A conduit/piping may be disposed through the bulk head fitting and terminate within the sump. The bulk head fitting may have an internal beveled surface which may receive an o-ring. A second compression nut is threaded onto the bulk head fitting. As the second compression nut is threaded onto the bulk head fitting, the bulk head fitting pushes the o-ring further down the internal beveled surface such that the o-ring compresses onto the conduit/piping as well as the internal beveled surface of the bulk head fitting so as to form a fluid tight seal therebetween. The second compression nut may be turned an additional one quarter turn to one half turn with a wrench after hand tightening. Beneficially, the conduit/piping sump penetration fitting does not have any additional mounting holes that might cause leakage or failure as in prior art fittings discussed above.

More particularly, a conduit/piping sump penetration fitting for providing a fluid tight seal between a conduit/piping and a sump wall is disclosed. The fitting may comprise a fitting body, first elastomeric seal, first nut, second elastomeric seal, o-ring and a second nut. The fitting body may define first and second end portions. The first end portion may have a flange. The second end portion may have an internal smooth beveled surface. An external surface of the fitting body being threaded.

The first elastomeric seal may be disposed between the sump wall and the flange of the fitting body. The first nut may be threadably engaged to the external thread of the fitting body. The second elastomeric seal may be disposed between the sump wall and the first nut. The first and second elastomeric seals may have a flat circular disc configuration and be fabricated from rubber. The o-ring may be sized and configured to be received on the internal smooth beveled surface of the second end portion of the fitting body with the o-ring protruding out of the first end portion. The second nut may be threadably engaged to the external thread of the fitting body. The second nut may have a flange for applying pressure to the o-ring when the second nut is threadably engaged to the external thread of the fitting body. An inner diameter of the o-ring reduces and compresses upon the conduit/piping as the second nut is threaded onto the external thread of the fitting body.

For sump walls that are curved, medial surfaces of the first and second elastomeric seals may be curved and correspond to the curvature of the sump walls.

In another embodiment, a conduit/piping sump penetration fitting for providing a fluid tight seal between a conduit/piping and a sump wall is disclosed. The fitting may comprise a fitting body, first elastomeric seal, first nut, second elastomeric seal, first o-ring, reducer, second o-ring and a second nut.

The fitting body may define first and second end portions. The first end portion may have a flange. The second end portion may have an internal smooth beveled surface. An external surface of the fitting body may be threaded.

The first elastomeric seal may be disposed between the sump wall and the flange of the fitting body. The first nut may be threadably engageable to the external thread of the fitting body. The second elastomeric seal may be disposed between the sump wall and the first nut. The first and second elastomeric seals may have a flat circular disc configuration and be fabricated from rubber. The first o-ring may be sized and configured to be received on the internal smooth beveled surface of the second end portion of the fitting body with the o-ring protruding out of the first end portion.

The reducer may have a plate and one or more conduit/piping sump penetration fittings attached to the plate. The plate may define opposed first and second sides. The first side of the plate may be disposed on the first o-ring.

The second o-ring may be disposed on the second side of the plate. The second nut may be threadably engaged to the external thread of the fitting body. The second nut may have a flange for applying pressure to the first and second o-rings when the second nut is threadably engaged to the external thread of the fitting body.

The first and second o-ring compresses upon the reducer plate as the second nut is threaded onto the external thread of the fitting body.

For curved sump walls, medial surfaces of the first and second elastomeric seals may be curved and correspond to the curvature of the sump wall.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a prior art fitting;

FIG. 2 is a perspective view of a conduit/piping sump penetration fitting;

FIG. 3 is a cross sectional view of the conduit/piping sump penetration fitting shown in FIG. 2;

FIG. 4 illustrates an o-ring disposed on an internal beveled surface of a bulk head fitting;

FIG. 5 illustrates the o-ring shown in FIG. 4 forming a fluid tight seal between a conduit/piping and the internal beveled surface;

FIG. 6 is a cross sectional view of a second embodiment of the conduit/piping sump penetration fitting;

FIG. 7 is a perspective view of the sump conduit/pipe fitting shown in FIG. 6;

FIG. 8 is a cross sectional view of a third embodiment of the conduit/piping sump penetration fitting; and

FIG. 9 is a cross sectional view of a fourth embodiment of the conduit/piping sump penetration fitting.

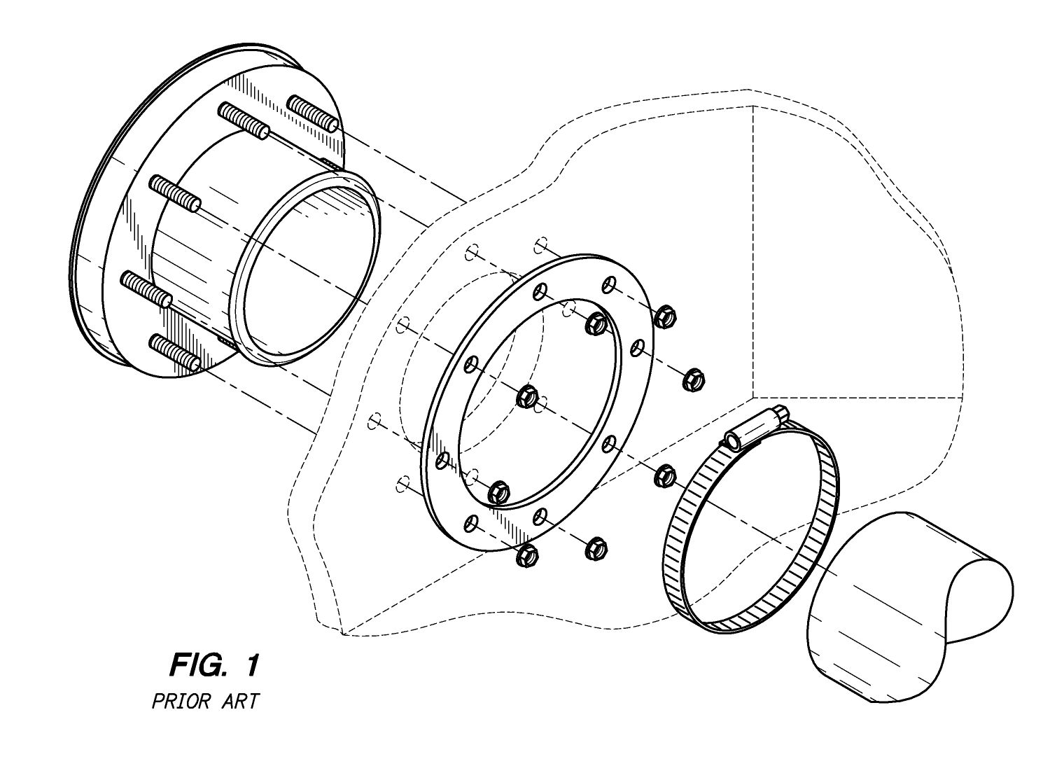

### DETAILED DESCRIPTION

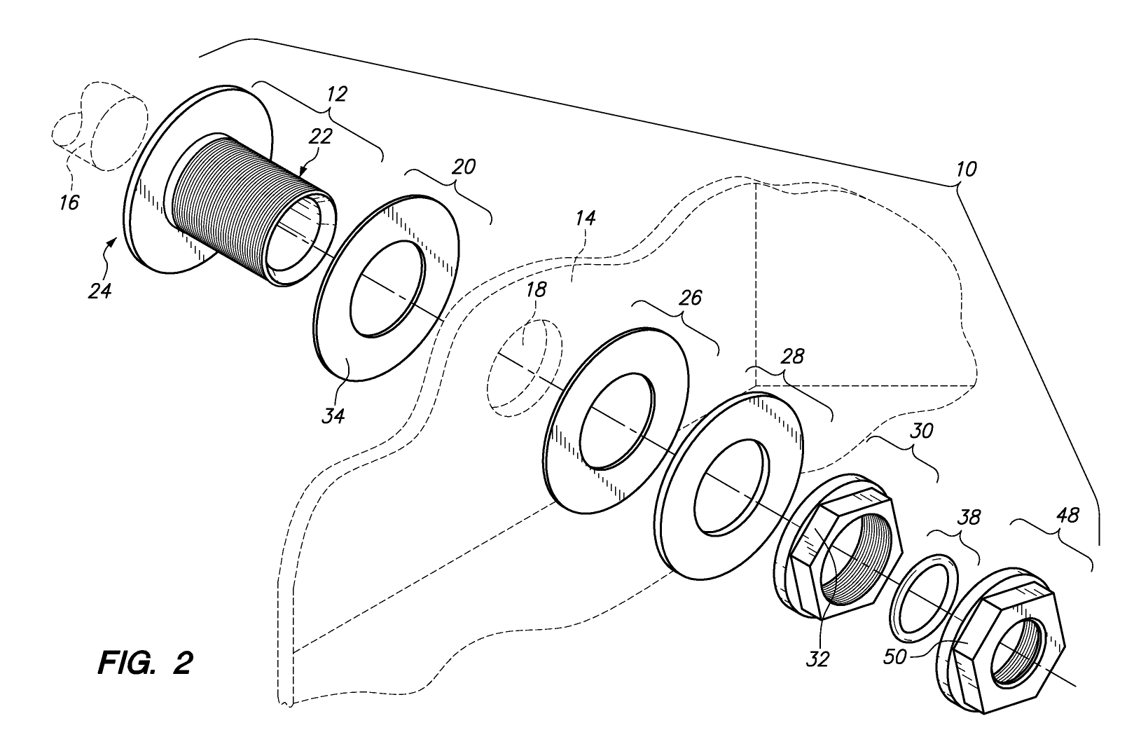

Referring now to FIG. 2, an exploded perspective view of a sump wall conduit/pipe seal 10 is shown. The conduit/piping sump penetration fitting 10 forms a fluid tight seal between (1) a bulk head fitting 12 of the conduit/piping sump penetration fitting 10 with the sump wall 14 and (2) the bulk head fitting 12 with a conduit/piping 16. The fluid tight seals are formed without any other holes through the sump wall 14 besides the main hole 18 for the conduit/piping 16. As such, the conduit/piping sump penetration fitting 10 provides for a reduced possibility or opportunity of leakage since the only hole that needs to be sealed is the main hole 18. In prior art systems, a plurality of mounting holes are formed about the periphery of the main hole 18. Each of these mounting holes in the prior art systems provides an opportunity for leakage. In the present conduit/piping sump penetration fitting 10, no other mounting holes except for the main hole 18 are necessary. As such, there is less opportunity for leakage.

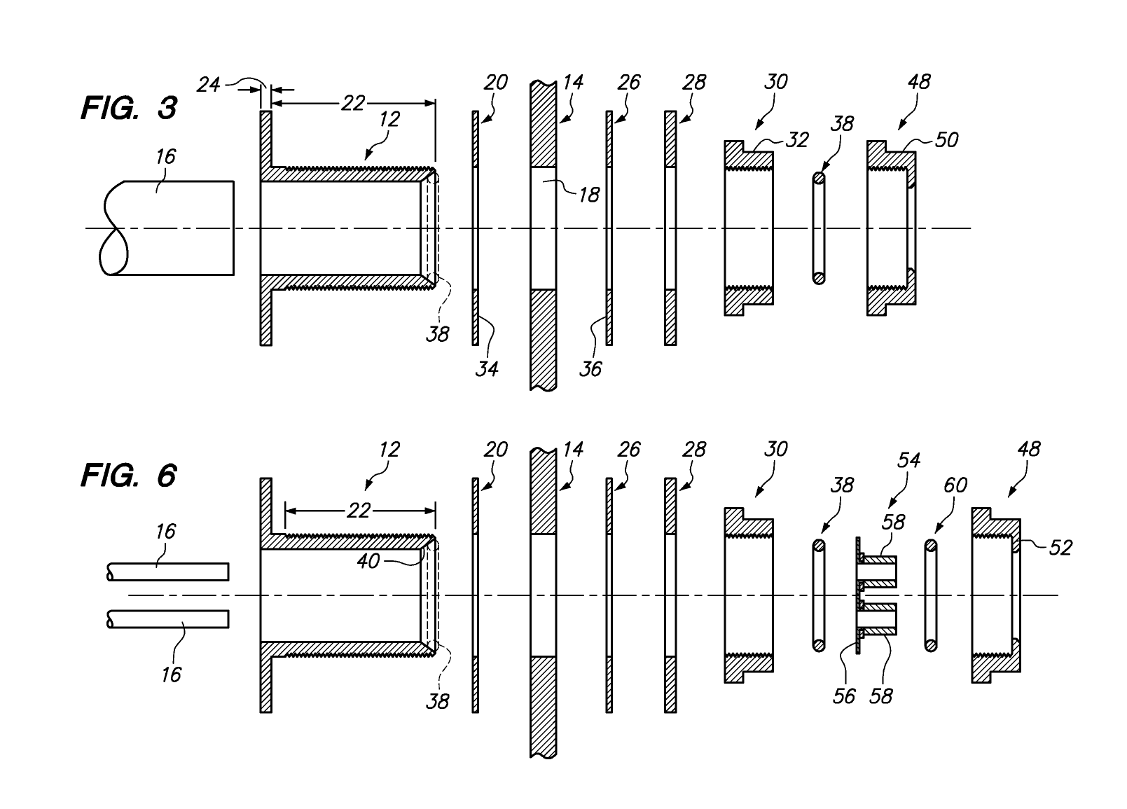

Referring now to FIG. 3, a main hole 18 is formed in the sump wall 14. The sump wall 14 may be a single or double sump wall 14. Although only a single sump wall 14 is shown, the various aspects discussed herein may be employed in conjunction with a double sump wall 14. Preferably, the main hole 18 is circular, as shown in FIG. 2. A flat rubber gasket 20 may be fitted over a threaded portion 22 of the bulk head fitting 12. The flat rubber gasket 20 may rest upon a flange 24 of the bulk head fitting 12. Preferably, an outer diameter of the flat rubber gasket 20 is about equal to an outer diameter of the flange 24 of the bulk head fitting 12. The threaded portion 22 of the bulk head fitting 12 is then pushed through the main hole 18 formed in the sump wall 14. On the other side of the sump wall 14, a second flat rubber gasket 26 is disposed over the threaded portion 22 of the bulk head fitting 12. Similar to the flat rubber gasket 20 discussed above, an outer diameter of the flat rubber gasket 26 may be about equal to an outer diameter of the flange 24 of the bulk head fitting 12. A generally rigid compression flange 28 typically fabricated from metal is placed over the threaded portion 22 of the bulk head fitting 12. A compression nut 30 is threaded onto the threaded portion 22 of the bulk head fitting 12. The compression nut 30 is at least hand tightened onto the threaded portion 22 of the bulk head fitting 12. The compression nut 30 may have a wrenching surface 32 (see FIG. 2) to allow further tightening of the compression nut 30 above hand tightening. By way of example and not limitation, the compression nut may be turned an additional one quarter turn to one half turn. Medial surfaces 34, 36 of the flat rubber gaskets 20, 26 may conform to the texture of the sump wall 14 so as to provide a fluid tight seal between the bulk head fitting 12 and the sump wall 14.

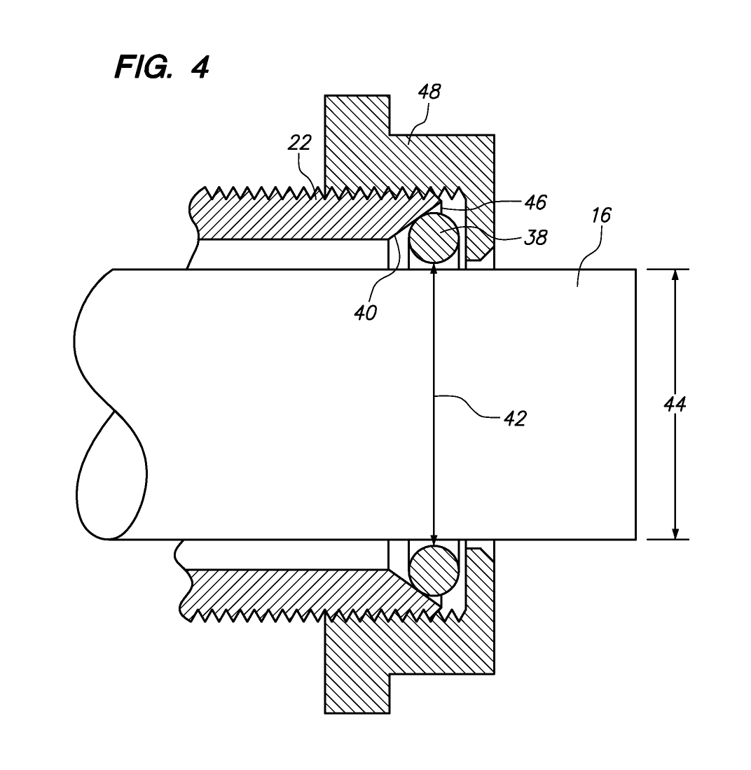

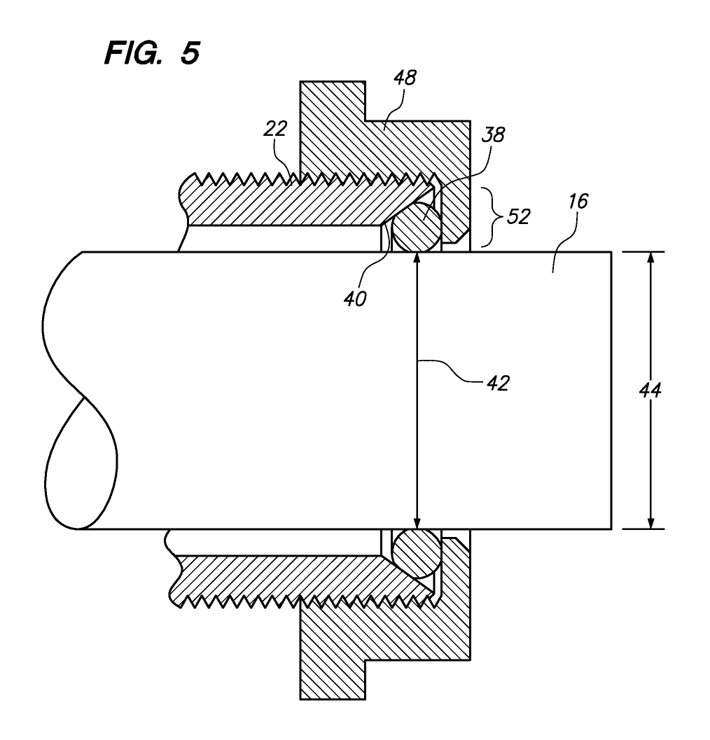

The conduit/piping 16 may be inserted through the bulk head fitting 12 and terminated on the other side of the sump wall 14, as shown in FIG. 4. An o-ring 38 may be disposed about the conduit/piping 16 and placed adjacent an internal beveled surface 40 of the threaded portion 22 of the bulk head fitting 12. The internal beveled surface 40 is formed at the distal end portion of the threaded portion 22. Preferably, in the relaxed state, an internal diameter 42 of the o-ring 38 is greater than an outer diameter 44 of the conduit/piping 16. Additionally, when the o-ring 38 rests upon the internal beveled surface 40, the o-ring 38 may protrude or extend beyond the distal end 46 of the threaded portion 22 of the bulk head fitting 12. A compression nut 48 may be threaded onto the threaded portion 22. The compression nut 48 may have a wrenching surface 50 (see FIG. 2) upon which a wrench may be applied or may be grasped by hand and used as a gripping surface. The compression nut 48 is further threaded onto the threaded portion 22. As the compression nut 48 is engaged to the threaded portion 22, as shown in FIG. 5, an inner flange 52 of the compression nut 48 pushes the o-ring 38 further into the internal beveled surface 40. This movement reduces the internal diameter 42 of the o-ring 38 until the internal diameter 42 of the o-ring 38 is equal to the outer diameter 44 of the conduit/piping 16. The o-ring 38 is compressed upon the conduit/piping 16. The inner side of the o-ring 38 is flattened on the conduit/piping and forms a fluid tight seal. Additionally, the o-ring 38 is pressed against the internal beveled surface 40 and forms a flat surface therewith. A fluid tight seal is formed between the internal beveled surface 40 and the o-ring 38.

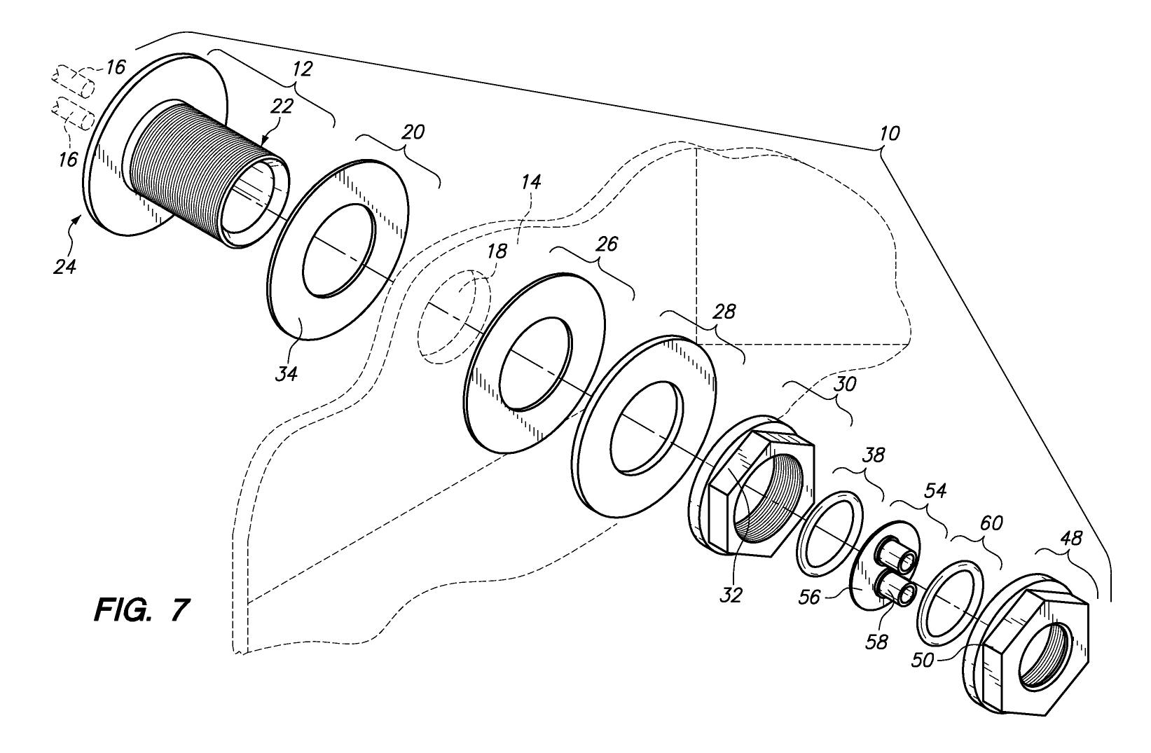

Referring now to FIGS. 6 and 7, an alternate embodiment is shown. In particular, the bulk head fitting 12 may be attached to the sump wall 14 as discussed above with a flat rubber gasket 20, flat rubber gasket 26, compression flange 28 and compression nut 30. This provides a fluid tight seal between the bulk head fitting 12 and the sump wall 14. The o-ring 38 may form a seal between the internal beveled surface 40 and a reducer 54. More particularly, the reducer 54 may have a plate 56 with one or more conduit/piping fittings 58 which form a fluid tight seal between the conduit/piping 16 and the conduit/piping fittings 58. o-ring 38 is laid adjacent the internal beveled surface 40. The plate 56 of the reducer 54 is laid on top of the o-ring 38. A second o-ring 60 is laid against the plate 56. The compression nut 48 is then threaded onto the threaded portion 22. The flange 52 of the compression nut 48 pushes the o-rings 38, 60 against the plate 56 of the reducer 54 and the internal beveled surface 40 as well as the flange 52. This provides a fluid tight seal between the reducer 54 and the bulk head fitting 12. A conduit/piping 16 is inserted through the conduit/piping fittings 58 which provides a fluid tight seal between the conduit/piping 16 and the fitting 58.

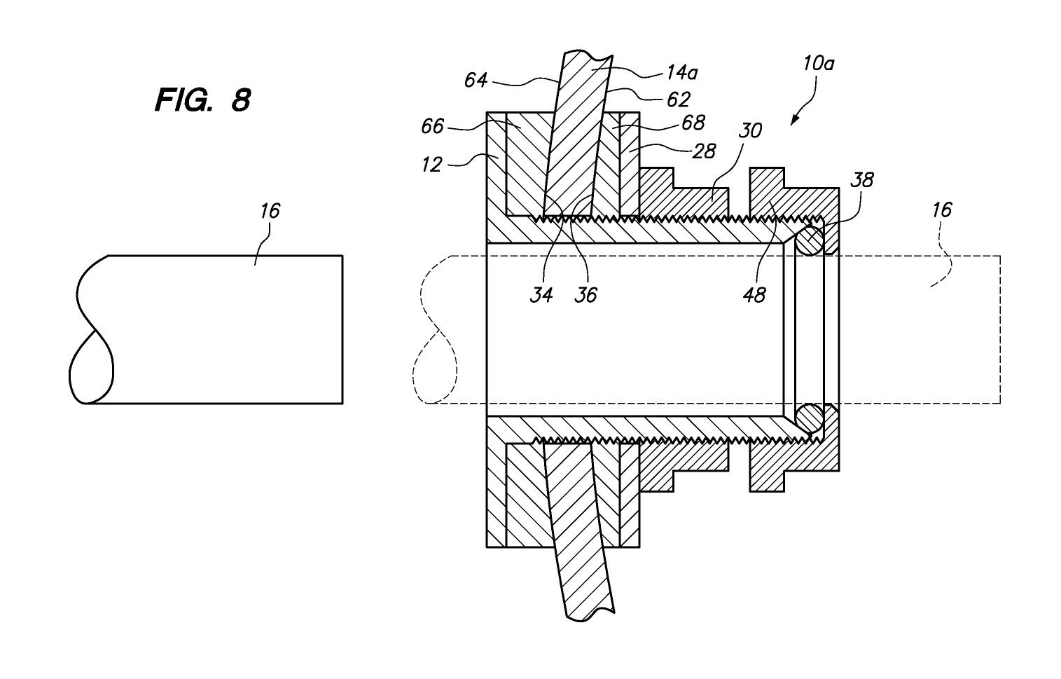

Referring now to FIG. 8, a conduit/piping sump penetration fitting 10a is shown for providing a fluid tight seal between a curved sump wall 14a and conduit/piping 16. In the sump walls 14 shown and described in FIGS. 2, 3, 6 and 7, the sump wall 14 has a generally flat wall which allows one to provide a fluid tight seal as described above. In the sump wall 14a shown in FIG. 8, the wall 14a is curved thereby defining a curved interior surface 62 and a curved exterior surface 64 of the sump wall 14a. In this example, the conduit/piping sump penetration fitting 10a comprises bulk head fitting 12, compression flange 28, compression nut 30 and compression nut 48. The conduit/piping sump penetration fitting 10a also comprises o-ring 38. The o-ring 38 provides a fluid tight seal between the conduit/piping 16 and the bulk head fitting 12 as described herein. Modified rubber gaskets 66, 68 provide a fluid tight seal between the bulk head fitting 12 and the sump wall 14a. In particular, the medial surfaces 34, 36 of the flat rubber gaskets 20a, 26a follow the curved contour of the curved sump wall 14a. This is shown in FIG. 8. When the compression nut 30 is cinched down onto the compression flange 28, the rubber gaskets 66, 68 press against the sump wall 14a to form a fluid tight seal. It is also contemplated that a reducer 54 and an additional o-ring 60 may be interposed between the o-ring 38 and compression nut 30, as shown in FIG. 8.

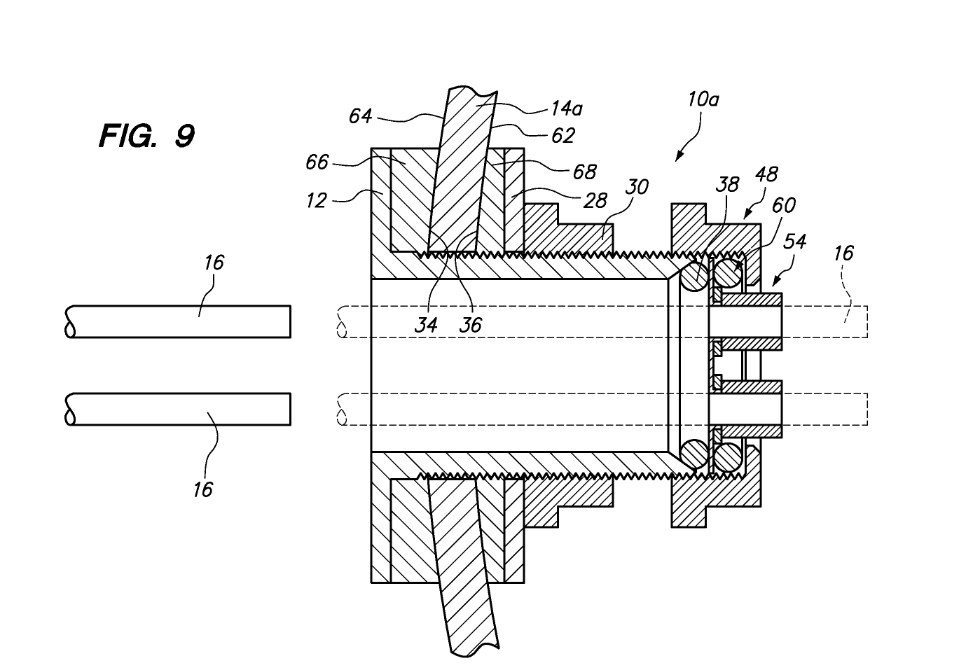

Referring now to FIG. 9, the conduit/piping sump penetration fitting 10a may also have a reducer 54 and an additional o-ring 60. The compression nut 48 may be threaded onto the threaded portion 22 of the bulk head fitting 12. The compression nut 48 compresses the o-rings 38, 60 to form a fluid tight seal between the reducer 54 and the bulk head fitting 12. The conduits/piping 16 may be inserted into the fittings of the reducer which forms a fluid tight seal with the conduits/piping. As discussed above, the reducer 54 may have one or more fittings 58 in any different combination and configuration.

The above description is given by way of example, and not limitation. Given the above disclosure, one skilled in the art could devise variations that are within the scope and spirit of the invention disclosed herein, including various ways of configuring the fitting 58. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A conduit/piping sump penetration fitting for providing a fluid tight seal between a conduit/piping and a sump wall, the fitting comprising:
a fitting body defining first and second end portions, the first end portion having a flange, the second end portion having an internal smooth beveled surface, an external surface of the fitting body being threaded;
a first elastomeric seal disposable between the sump wall and the flange of the fitting body;
a first nut threadably engageable to the external thread of the fitting body;
a second elastomeric seal disposable between the sump wall and the first nut;
an o-ring sized and configured to be received on the internal smooth beveled surface of the second end portion of the fitting body with the o-ring protruding out of the first end portion;
a second nut threadably engaged to the external thread of the fitting body, the second nut having a flange for applying pressure to the o-ring when the second nut is threadably engaged to the external thread of the fitting body;
wherein an inner diameter of the o-ring reduces and compresses upon the conduit/piping as the second nut is threaded onto the external thread of the fitting body.

2. The fitting of claim 1 wherein the first and second elastomeric seals have a flat disc configuration.

3. The fitting of claim 1 wherein the first and second elastomeric seals are fabricated from rubber.

4. The fitting of claim 1 wherein medial surfaces of the first and second elastomeric seals are curved so as to correspond to a curved sump wall.

5. A conduit/piping sump penetration fitting for providing a fluid tight seal between a conduit/piping and a sump wall, the fitting comprising:
a fitting body defining first and second end portions, the first end portion having a flange, the second end portion having an internal smooth beveled surface, an external surface of the fitting body being threaded;
a first elastomeric seal disposable between the sump wall and the flange of the fitting body;
a first nut threadably engageable to the external thread of the fitting body;
a second elastomeric seal disposable between the sump wall and the first nut;
a first o-ring sized and configured to be received on the internal smooth beveled surface of the second end portion of the fitting body with the o-ring protruding out of the first end portion;
a reducer having a plate and one or more conduit/piping fittings attached to the plate, the plate defining opposed first and second sides, the first side of the plate disposable on the first o-ring;
a second o-ring disposed on the second side of the plate;
a second nut threadably engaged to the external thread of the fitting body, the second nut having a flange for applying pressure to the first and second o-rings when the second nut is threadably engaged to the external thread of the fitting body;
wherein an inner diameter of the first o-ring reduces and compresses upon the conduit/piping as the second nut is threaded onto the external thread of the fitting body.

6. The fitting of claim 5 wherein the first and second elastomeric seals have a flat disc configuration.

7. The fitting of claim 5 wherein the first and second elastomeric seals are fabricated from rubber.

8. The fitting of claim 6 wherein medial surfaces of the first and second elastomeric seals are curved so as to correspond to a curved sump wall.
